(19) United States
(12) Patent Application Publication
(10) Pub. No.: US 2008/0004938 A1
(43) Pub. Date: Jan. 3, 2008

(54) System and method for creating a genre index

(76) Inventor: Robert Maerz, Stone Harbor, NJ (US)

Correspondence Address: LAWRENCE SUNG0- S2IPLAW, PLLC, 401 9TH STREET, NW, SUITE 900-NIXON PEABODY LLP, WASHINGTON, DC, 20004-2128, US

(21) Appl. No.: 11/454,304

(22) Filed: Jun. 16, 2006

(51) Int. Cl. G07G 1/00

(52) U.S. Cl. 705/10

(57) ABSTRACT

The present invention relates generally to a method of creating a tool that may accurately capture social mood trends. More specifically, the invention may include creating a genre index to capture trends in sales revenue, ratings, and/or other volume data for a variety of genres in a particular industry, and may further include using the genre index to hedge against loss of revenue in that industry. The invention also relates to a method of creating a tradable instrument for the purpose of hedging inherent business risks and for general trading and/or investment purposes.

### CROSS REFERENCE TO RELATED APPLICATION

The present application claims the benefit under 35 U.S.C. §119(e) of U.S. provisional application Ser. No. 60/692,792, filed on Jun. 22, 2005, entitled “System and Method for Creating a Genre Index,” which is incorporated herein by reference in its entirety.

### FIELD OF THE INVENTION

The present invention relates generally to creating a tool that may accurately capture social mood trends. More specifically, the invention may include creating an index to capture trends in, for example, sales revenue, ratings, and other volume data for a variety of genres in a particular industry, and may further include using the index to hedge against loss of revenue in that industry. The invention also relates to a method of creating a tradable instrument for the purpose of, for example, hedging inherent business risks and/or for general trading and investment purposes.

### BACKGROUND OF THE INVENTION

Successful project selection in certain industries is inherently risky. If a project is selected that is initially unpopular, a company is subject to heavy losses because initial advantages can lead to extreme differences in ultimate results with respect to profits. The entertainment industry, for example, is significantly influenced by the opinions of early customers. For example, if a movie, play, song or TV show has high ratings during its debut, the opinions of those early customers will spread rapidly throughout communities. The early ratings are reported in the news as a top-grossing movie or highly rated TV show, for example, which in turn, attracts more people to watch the particular movie or television show. This phenomenon is known as recursive demand dynamics, or so-called “contagion,” or “bandwagon effect.”According to this phenomenon, the amount of future demand depends on the amount demand already received.

Because participants in the entertainment industry are aware of the recursive demand dynamics phenomenon, participants try to maximize the exposure of a project to the audience and create so-called “buzz” in order to make a profit. Participants often spend large amounts of money upfront to obtain a cast of name stars, feature spectacular special effects, and open on many screens at once. This spending strategy is risky because if a project does not catch on, the money would be spent to no avail. Losses incurred from the initial investment for these buzz-creating features are compounded by expenses such as overhead, distribution charges, accounting, etc. In spite of the high profits that certain movies earn, most movies are unprofitable. It is estimated that approximately six percent of movies earn eighty percent of total profit. The entertainment industry is a winner-take-all industry, and therefore, an inherently risky business.

Currently, one way to predict the mood of society in order to predict which types of projects are more likely to be successful is by an insider selection process and/or surveying the opinion of the general public as to what they desire during any given time period. However, predicting which types of projects are likely to be successful based on insider selection or survey results alone is generally less than adequate. Those predictions are not based on concrete financial and economic data. Rather they are merely based on insider and/or some public opinion. There is a need in the market for a better method to predict social mood trends. This would allow a better selection of likely successful projects so that a large amount of money is not wasted on investment in projects that are not truly in tune with the sentiment of the general public for any given time period.

A high correlation may, for example, exist between social mood trends and important trends in the entertainment industry as well as general financial and economic events. For example, the Walt Disney Company released its first feature length cartoon in 1937, a year atop a five-year bull market. These films stayed popular for the next thirty years as the market emerged from its depression lows in 1932. For the next sixteen years, as stock prices fell, along with social mood, people began to think of Disney style productions as silly and sentimental. The studio's productivity fell by more than fifty percent during this period. When the bull market returned in the 1980s and 1990s, so did the popularity of animation, along with renewed interest in productions that might previously have been considered too silly or sentimental. On the other side of the spectrum, horror movies, such as Frankenstein, Dracula, Dr. Jekyll and Mr. Hyde, and King Kong, flourished during years of bear market time periods.

Moreover, in the 1950s and early 1960s, as a bull market was underway, “feel good” music was highly popular. However, during the following bear market, music became weary, angry and cynical as punk rock became popular.

There is a need for unbiased more accurate prediction tools to gauge the entertainment desires of the public that can then be used to properly engage entertainment resources.

### SUMMARY OF THE INVENTION

The present invention provides, for example, innovative techniques for creating a tool that enhances the ability to anticipate the mood of the general public. Known methods of anticipating the mood of the general public by, for example, the entertainment industry, rely primarily on subjective insider opinions and, occasionally, include taking surveys from the general public about the types of genres of projects that they desire. By contrast, the present invention may, for example, use financial and economic data to anticipate the mood of the public. Anticipating the mood of the public can help to predict the genres of projects that are likely to be more or less profitable. The present invention may, thus, prevent large amounts of money from being wasted on the development of unprofitable projects that are not in the same genres that the general public desires for any given time period.

The present invention may thereby create a genre index that more accurately predicts which types of projects are “in tune” with the types of genres that the public desires compared to traditional methods, by using unbiased data. The indexes, thus, may have a basis in the real cash market or actual use or participation by the public, rather than having a basis primarily based on insider or surveyed opinion. Predicting which types of projects are aligned with the desires of the public better helps companies or individuals pick profitable projects for development, investment, or management.

One object of an embodiment of the present invention is to provide a method of creating a genre index for the purpose of capturing trends in sales revenue, ratings and other volume data. Volume data includes, for example, data from sales, leases, licenses, rentals, program attendance, use, downloads, or other revenue-generating financial or economic transactions for various products associated with a particular industry, and may be used in conjunction with survey results and/or insider opinion. This object is accomplished by collecting sales revenue, ratings, and/or other volume data for one or more products in one or more industries. Once the data is collected and quantified, the data may, for example, be segregated into various genres. Once the data is segregated by genre, the data may then be analyzed to identify trends within the data. Finally, the data may be communicated to, for example, show possible trends in the data.

Another object of an embodiment of the present invention is to provide a method of creating a genre index for the purpose of capturing data trends, the method including, for example, collecting sales revenue, ratings, and/or other volume data for one or more products in one or more industries, wherein the industry is an entertainment, software, or pharmaceutical industry.

A further object of an embodiment of the present invention is to provide a method of creating a genre index for the purpose of capturing data trends, the method including, for example, collecting sales revenue, ratings, and/or other volume data for one or more products in one or more industries, wherein that industry is an entertainment industry, and wherein entertainment industry includes, for example, a selection of music, movies, video games, television programs, and radio programs.

Another object of an embodiment of the present invention is to provide a method of creating a genre index for the purpose of capturing trends in sales revenue, ratings and/or other volume data, wherein the sales revenue, ratings and/or other volume data may, for example, be selected from a group of sales, rentals, leases, licenses, program attendance, use, downloads, or other revenue-generating transactions for various genres of products.

Another object of an embodiment of the present invention is to provide a method of creating a genre index for the purpose of capturing trends in sales revenue, ratings, and/or other volume data, wherein the sales revenue, ratings and/or other volume data may, for example, be selected from a group of music sales, rentals, leases, licenses, program attendance, use, downloads, or other revenue generating transactions for various genres of music products.

Another object of an embodiment of the present invention is to provide a method of creating a genre index for the purpose of capturing trends in sales revenue, ratings and/or other volume data, wherein the sales revenue, ratings and/or other volume data may, for example, be selected from a group of movie sales, rentals, leases, licenses, program attendance, use, downloads, or other revenue generating transactions for various genres of movie products.

Another object of an embodiment of the present invention is to provide a method of creating a genre index for the purpose of capturing trends in sales revenue, ratings, and/or other volume data, wherein the sales revenue, ratings, and/or other volume data may, for example, be selected from a group of video game sales, rentals, leases, licenses, program attendance, use, downloads, or other revenue generating transactions for various genres of video games.

Yet another object of an embodiment of the present invention is to provide a method of creating a genre index for the purpose of capturing data trends in sales revenue, ratings, and/or other volume data, wherein the sales revenue, ratings, and/or other volume data may, for example, include television program ratings for various genres of television programs which may be used in combination with other financial data.

A further object of an embodiment of the present invention is to provide a method of creating a genre index for the purpose of capturing data trends in sales revenue, ratings, and/or other volume data, wherein the sales revenue, ratings, and/or other volume data may include radio program ratings for various genres of radio programs and which may be used or correlated with other financial data.

Another object of an embodiment of the present invention is to provide a method of creating a genre index for the purpose of capturing trends in sales revenue, ratings and/or other volume data, the method including, for example, collecting sales revenue, ratings and/or other volume data for one or more products in one or more industries wherein the products are selected, for example, from a group of music CDs, music downloads, movie DVDs, movie home video, movie downloads, or video games.

Another object of an embodiment of the present invention is to provide a method of creating a genre index for the purpose of capturing trends wherein the trends may include social mood trends.

A further object of an embodiment of the present invention is to provide a method of creating a genre index for the purpose of capturing trends wherein the method includes, for example, analyzing collected, quantified, and segregated sales revenue, ratings, and/or other volume data, and communicating the results of the analyzed sales revenue, ratings, and/or other volume data showing possible trends in the data, and wherein communicating the results may further include using a visual representation of the data, and wherein the visual representation of the data is a graph or chart.

Another object of an embodiment of the present invention is to provide a method for creating a genre index and using the genre index to predict successful projects for production for companies in industries where picking successful projects is inherently risky.

Another object of an embodiment of the present invention is to provide a method of creating a genre index and using the genre index to enable investors to build diversified synthetic libraries of projects.

Yet another object of an embodiment of the present invention is to provide a method of creating a genre index and using the genre index to hedge against underperforming project selection in a particular genre in a particular industry.

Another object of an embodiment of the present invention is to provide a method for creating a genre index and using the genre index to directly trade trends in specific genres in the market.

Another object of an embodiment of the present invention is to provide a method for creating a genre index and using the genre index to perform arbitrage in the market.

Another object of an embodiment of the present invention is to provide a method for creating a genre index and converting the genre index into a tradable instrument in the financial market.

Yet another object of an embodiment of the present invention is to provide a method for creating a genre index and converting the genre index into one or more investable products and wherein converting the genre index further includes converting the genre index on a cash-settled basis.

Another object of an embodiment of the present invention is to provide a method for creating a genre index and licensing rights to use the genre index to futures, options, or stock exchanges.

Another object of an embodiment of the present invention is to provide a method for creating a genre index and licensing rights to use the genre index to money management firms or investment banks to create investable products, and wherein investable products may, for example, be selected from a group of mutual funds, hedge funds, or exchange traded funds.

A further object of an embodiment of the present invention is to provide a method for creating a genre index and to use the genre index to produce a consumer confidence index or similar general economic indexes.

Another object of an embodiment of the present invention is to provide a method for creating a genre index and licensing rights to use the genre index to third-party data suppliers.

A further object of an embodiment the present invention is to provide a method for creating a tradable instrument for the purpose of exchange within a financial market that may, for example, include collecting sales revenue, ratings, and/or other volume data for one or more products in one or more industries; quantifying the sales revenue, ratings, and/or other volume data; segregating the sales revenue, ratings, and/or other volume data by genre category; analyzing the data for the purpose of identifying trends in the data; and converting the data into a tradable instrument on a cash-settled basis.

A further object of an embodiment of the present invention is to provide a method for creating a tradable instrument and comparing the tradable instrument against other similar tradable instruments in various genres to mine for useful information.

A further object of an embodiment of the present invention is to provide a method for creating a tradable instrument and licensing rights to use that tradable instrument to various futures, options, and stock exchanges.

A further object of an embodiment of the present invention is to provide a method for creating a tradable instrument and licensing rights to use that tradable instrument to money management firms or investment banks to create one or more investable products, and wherein investable products may, for example, be selected from a group of mutual funds, hedge funds, or exchange traded funds.

A further object of an embodiment of the present invention is to provide a method for creating a tradable instrument and licensing rights to use the tradable instrument to third-party data suppliers.

### BRIEF DESCRIPTION OF THE DRAWINGS

Some features and advantages of the invention are described with reference to the drawings of certain preferred embodiments, which are intended to illustrate and not to limit the invention.

FIG. 1 illustrates one example of a flow diagram of a method of creating a genre index according to one embodiment of the present invention.

FIG. 2 illustrates one example of a chart showing aggregated volume data for an exemplary action-adventure genre according to another embodiment of the invention.

FIG. 3 illustrates one example of a flow diagram of a method of creating a genre index according to a further embodiment of the invention.

### DETAILED DESCRIPTION OF THE INVENTION

It should be understood that this invention is not limited to the particular methodology, protocols, etc., described herein and, as such, may vary. The terminology used herein is for the purpose of describing particular embodiments only, and is not intended to limit the scope of the present invention, which is defined solely by the claims.

As used herein and in the claims, the singular forms “a,” “an,” and “the” include the plural reference unless the context clearly indicates otherwise. Thus, for example, a reference to a database may be a reference to one or more such databases, including equivalents thereof known to those skilled in the art unless the context of the reference clearly dictates otherwise.

All patents and other publications identified are incorporated herein by reference for the purpose of describing and disclosing, for example, the methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason.

Unless defined otherwise, all technical terms used herein have the same meaning as those commonly understood to one of ordinary skill in the art to which this invention pertains. Although any known methods, devices, and materials may be used in the practice or testing of the invention, the preferred methods, devices, and materials in this regard are described here. By way of example, the following terminology is used within this application and may be interpreted in the following manner. “Volume data” would include, for example, data from sales, leases, licenses, rentals, program attendance, use, downloads, or other revenue-generating transactions.

A genre index may be created by collecting sales revenue, ratings, and/or other volume data for one or more products in one or more industries. Volume data may include data from sales, leases, licenses, rentals, program attendance, use, downloads, or other revenue-generating or financial transactions or actual use of participation for various products associated with a particular industry. For example, volume data could be selected from a group of music sales, rentals, leases, licenses, program attendance, use, downloads, or other revenue generating transactions for various genres of music products such as music CDs or music downloads.

Volume data could also be selected from a group of movie sales, rentals, leases, licenses, program attendance, use, downloads, or other revenue-generating transactions for various genres of movie products such as movie DVDs, movie home video, or movie downloads. Moreover, volume data, could, for example, be selected from a group of video game sales, rentals, leases, licenses, use, downloads, or other revenue-generating transactions for various genres of video game products such as video games or video downloads. Furthermore, volume data could consist of television program ratings for various genres of television programs such as the Nielsen ratings, or radio program ratings for various genres of radio programs, such as the Arbitron ratings based, for example, on actual viewing or listening.

The genre index could be used in a variety of industries, such as the entertainment industry, the software industry, or the pharmaceutical or medical products industry. The entertainment industry includes, but is not limited to categories such as music, movies, video games, television programs, DVDs, in-demand cable, satellite TV, internet media, and radio programs, for example.

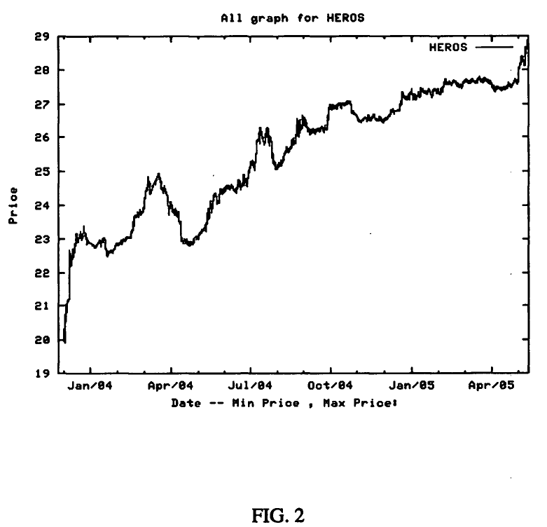

The sales revenue, ratings, and/or other volume data may then be quantified. Once the data is collected and quantified, the data may be segregated into various genres. For example in the movie category, data could be segregated into genres such as the “Family” genre, and then further segregated into sub-genres within that category, such as “Children's Entertainment,” “Family Adventure,” “Family Comedy,” and “Children's Fantasy.” Other genres could be used, for example, “Action,” “Adventure,” “Drama,” “Science Fiction,” “Classics,” “Fantasy,” etc. The same could be done for music recordings, television programs, video games, or any other form of popular entertainment for which volume data could be obtained. Once the data is segregated by genre, the data may then be analyzed to identify trends within the data. The data may be analyzed, for example, by first plotting the genre price over time as shown in FIG. 2. The data in FIG. 2 shows an example of an “Action-Adventure” genre price plotted over time. Analyzing this data may, for example, show trends that may help predict future trends in a genre.

Finally, data may be communicated to show trends in the data. The data could be communicated through a visual representation of the data, such as a graph or chart, and compared against other indexes in a particular genre to mine for useful information, such as social mood trends, for example. The data may be communicated, for example, by computer, printed charts, through a public exchange, through financial institutions, over the counter trading, hedging activity and valuing derivative instruments, through entertainment companies with libraries that want to hedge the value of against the vagaries of public taste, piracy and the like. The data may be represented in a chart plotting the average trading price of a genre over time showing trends in how entertainment is received by the public such as the exemplary chart shown in FIG. 2. Such charts may be used to glean useful information about future trends in different genres.

Agreements may also be entered into with data suppliers allowing the right to use segregated sales revenue, ratings, and/or other volume data and the right to use the current data from data suppliers to update the genre indexes in real-time. Various futures, options and stock exchanges could be approached about making the genre indexes into investable and tradable products, on a cash-settled basis, on or more of their exchanges. Licensing fees could be collected for use of the genre indexes. Once agreements are obtained with one or more exchanges to make the indexes tradable, then agreements with other organizations, such as money management firms and investment banks, could be made to created investable products based on the indexes such as mutual funds, hedge funds, or exchange traded funds. Again, licensing fees could be collected for use of the genre indexes. Finally, agreements could be made with third-party data suppliers, for example, Bloomberg or Dow Jones. Once again, licensing fees could be collected for the use of the genre indexes. Furthermore, a consulting service could provide proprietary research and analysis for a fee, based on the genre indexes to interested third parties.

Specific applications of an entertainment genre index may include: (1) general improvement of the project selection process; (2) diversification; (3) limitation of risk; (4) speculation, investment, and trading; (5) arbitrage; (6) yield and/or revenue enhancement of existing libraries; and (7) application of advertisement and economic and social trend analysis.

### 1. General Improvement of Project Selection Process

A genre index can give market participants and industry players an unbiased forecast of future profitability because it may not be based on opinion. Analysis techniques that are currently used to attempt to forecast trends and trend changes in the financial industry, for example, could be applied to entertainment genres. Projects that are in genres in a rising trend, may, on the whole, have a higher probability of success because their general themes are more in tune with public tastes for a particular time. Furthermore, if a genre index is exchange traded, then market participants may likely attach a premium or a discount to various projects based on their view of the index's future outlook. For example, in the movie industry, the index's future outlook may be based on projects currently in production, in the box office, or on their way to home video. The same may likely be true for music genres, television programming genres, video game genres, and radio programming genres.

### 2. Diversification

It is generally known that wide diversification reduces risk in the financial industry. In the entertainment industry, the costs of producing and promoting individual entertainment projects are often very high. Therefore, wide diversification in the entertainment industry is currently not financially preferable.

Exchange traded genre indexes can give developers, for example, the opportunity to add wide diversification to their annual production portfolios by giving them the ability to structure their own synthetic “library” of projects at a relatively low cost. For instance, developers may want to produce projects in an unpopular genre because they think the quality of the project is high enough to overcome the disadvantage of unpopularity. Developers could hedge their performance by purchasing derivatives based on genre indexes in better performing genres. For example, if a studio produces a string of failed projects, it could potentially hedge itself by buying derivatives based on genre indexes that include the performance of successful projects made by their competitors. Investors in individual projects without the capital to widely diversify could hedge themselves by adding exposure to genre index derivatives so that all of their exposure would not be limited to just one or two productions.

### 3. Limitation of Risk

If a company has a library of entertainment products that may be, for example, on the verge of going out of date or are underperforming, the company may be able to hedge against this with exchange traded genres indexes. A television network could potentially hedge against poor or underperforming choices in its program lineup. New television shows that may have problems finding an initial audience could be given a chance by the network since the network would be able to hedge its performance with a genre index that covered that program's genre. The genre index may allow the network to profit from the performance of that particular genre, even though they might lose advertising revenues due to low Nielsen ratings for that show. Music production and distribution companies could hedge their output in a similar fashion with music genre indexes. Video game manufacturers could do the same with video game genre indexes, and radio stations could do the same with radio genre indexes.

The entertainment industry is a business of extremes where profits tend to cluster among only a few projects. It is possible that in any given year, one company could own most or all of the highly profitable projects and shut out the rest of the competition. Hedging against the risk of being shut out of the industry with genre indexes could likely smooth a company's earnings stream by reducing the need to have a big “hit” every year. Additionally, the motion picture industry estimates that it loses $3.5 to $4 billion a year to piracy. Genre indexes could also be used to hedge against those piracy losses.

### 4. Speculation, Investment, and Trading

At present, there are few trades on trends in the entertainment industry other than buying stock in the major media conglomerates. Buying stock in media conglomerates is not a good option for investors and traders because opportunities are diluted due to the sheer size and complexity of those companies. Genre indexes may enable investors, traders, and speculators to directly trade trends in specific genres in motion pictures, television, music, and video games, and take advantage of any volatility the indexes present.

Certain aspects of the present invention may be new unique ways for investors to hedge their exposure to the stock market. Individual investors could use genre indexes to build the equivalent of their own film and television libraries. Video game aficionados could have the opportunity to build and potentially profit from their own portfolios of video game genres. Amateur music producers could potentially do the same with a portfolio of music genres. In addition, there are numerous possibilities to use genre indexes in a money management capacity. It is conceivable that Exchange Traded Funds could be created based on genre indexes, as well as mutual funds and hedge funds.

### 5. Arbitrage

Numerous arbitrage opportunities may exist for various genre indexes. There may be an opportunity to trade the spread between R rated motion pictures as a genre and the “family” film genre (rated PG-13, PG, and G). Furthermore, the present invention may enable inter-market spreading opportunities between various genre indexes and financial markets if the correlation between them supports such spreads because, for example, it is strong. Certain genre indexes, or a combination of them, may be excellent tools for hedging against a bear market or reducing the risk or volatility of a bull market.

### 6. Yield and/or Revenue Enhancement of Existing Libraries

Many of the large media companies own large libraries of films, television shows, and music from which they continue to earn revenues. The existence of genre indexes can allow the creation of exchange traded options on genre indexes or, for example, allow investment banks to create over-the-counter options specifically tailored to companies. Genre indexes also may allow companies to generate additional income. The companies may incur little risk because they own the product and because the options can be cash-settled. Cash-settlement is a settlement procedure where, for example, at the expiration of a futures or options contract, the cash value of the product can be delivered to the owner instead of the actual product itself. However, the companies may be able to generate additional premium income above the revenues from their existing libraries. Furthermore, if individuals and institutions purchased an interest in the indexes as a futures contract, thereby creating their own synthetic library, they may be able to also sell options to provide downside protection and to generate additional income.

### 7. Economic and Social Trend Analysis

Because genre indexes may, for example, be as much a tool for measuring social mood as they would be for measuring economic activity in the entertainment business, it is reasonable to assume that it is possible that one, or some combination of genre indexes, could produce a kind of “consumer confidence” index that may be much more of a leading indicator or coincident indicator than the ones currently used. For example, current consumer confidence indexes tend to lag economic activity. In addition, a wide variety of genres indexes may allow the business community to have a sense of the pulse of the global community and their changing tastes in ways more sensitive than they ever had before.

In sum, to create a genre index, one or more of the following steps or other similar steps may be taken:
1. Contact data suppliers and purchase or obtain pertinent sales revenue, ratings, and/or other volume data regarding movie, music, video game, television, radio products, and/or other products sold in the entertainment industry. Data could be compiled on a weekly or monthly basis.
2. Analyze and segregate the sales revenue, ratings, and/or other volume data by genre to identify any trends in the data and any relationships between the indexes themselves and other available indexes that measure social or economic activity.
3. Graph data on a weekly line or bar chart and compare the data against other indexes in that category, against indexes in other formats, and against other social and economic data to mine for useful information. Tabular data could also be available showing the values of each index as far back as data is obtained.
4. Enter into agreements with the data suppliers allowing the right to use the obtained data into an index for purposes other than internal research, and allowing the right to use current data to update the indexes in real time.
5. Seek agreements with various futures, options, and stock exchanges about making the genres indexes into investable and tradable products, on a cash-settled basis, on one or more exchanges in return for licensing fees.
6. Seek agreements with other organizations such as money management firms or investment banks to create investable products based on the indexes such as mutual funds, hedge funds, or exchange traded funds in return for licensing fees.
7. Seek agreements with third party data suppliers to supply genre index data to customers in return for licensing fees.
8. Provide a consulting service that would provide proprietary research and analysis based on the genre indexes to interested third parties in return for licensing fees.

An example embodiment and implementation of the invention is described with reference to the drawings and figures.

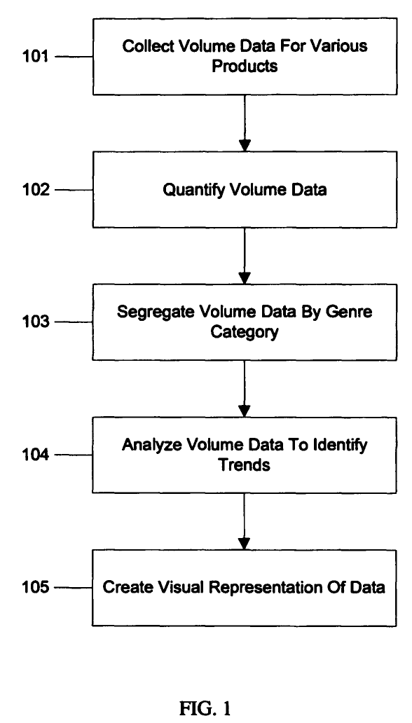

FIG. 1 illustrates one example of a flow diagram of a method of creating a genre index. First, volume data may be collected for one or more products in one or more industries (101). Next, the volume data may be quantified (102) and segregated by genre category (103). Then the volume data may be analyzed to identify trends in the data (104). Finally, the results of the volume data may be communicated to show possible trends in the data (105). One or more of the aforementioned steps or other similar steps may be taken to create a genre index.

FIG. 2 shows one example of a chart used to communicate genre data. This chart shows action adventure genre trend over a period of time.

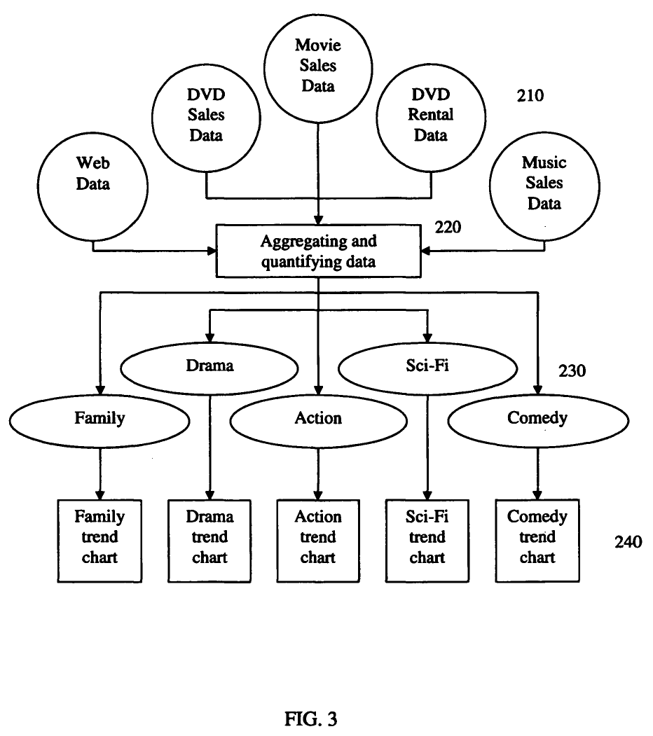

FIG. 3 shows a flow diagram according to another embodiment of the present invention. Volume data from various entertainment resources is collected 210. In this embodiment, for example, web data, DVD sales data, movie sales data, DVD rental data and music sales data are collected. Other data may be used without deviating from the spirit of the invention. After the data is collected, the data may be aggregated and/or quantified 220 and then segregated into genres 230. The step of aggregating and/or quantifying data 220 may include aggregating the data over time to show historical trends. In this embodiment data is segregated into five exemplary genres: family, drama, action, science fiction, and comedy. Other genres may be included. Furthermore, these genres may be further divided into sub-genres. The data may then be communicated via genre trend charts 240 such as the charts shown in FIG. 2.

Although the invention has been particularly shown and described with reference to the various embodiments provided above, it will be understood by those skilled in the art that various changes in form and detail may be made to these various embodiments without departing from the spirit and scope of the invention.

What is claimed is:

1. A method of creating a genre index for the purpose of capturing data trends comprised of:
a. collecting volume data for one or more products in one or more industries;
b. quantifying said volume data;
c. segregating said volume data by genre category;
d. analyzing said volume data to identify trends in the data; and
e. communicating results of analyzed volume data showing possible trends in said data.

2. The method of claim 1 wherein said one or more industries comprises an entertainment industry.

3. The method of claim 2 wherein said entertainment industry comprises a selection from a group of music, movies, video games, television programs, and radio programs.

4. The method of claim 1 wherein said one or more industries comprises a pharmaceutical industry.

5. The method of claim 1 wherein said one or more industries comprises a software industry.

6. The method of claim 1 wherein said volume data comprises insider opinion data and further comprises financial data.

7. The method of claim 1 wherein said volume data is selected from a group of sales, rentals, leases, licenses, program attendance, use, downloads, and other revenue-generating transactions.

8. The method of claim 1 wherein said volume data is selected from a group of music sales, rentals, leases, licenses, program attendance, use, downloads, and other revenue-generating transactions for various genres of music products.

9. The method of claim 1 wherein said volume data is selected from a group of movie sales, rentals, leases, licenses, program attendance, use, downloads, and other revenue-generating transactions for various genres of movie products.

10. The method of claim 1 wherein said volume data is selected from a group of video game sales, rentals, leases, licenses, use, or downloads, and other revenue-generating transactions for various genres of video game products.

11. The method of claim 1 wherein said volume data comprises television program ratings for various genres of television programs.

12. The method of claim 1 wherein said volume data comprises radio program ratings for various genres of radio programs.

13. The method of claim 1 wherein said products are selected from a group of music CDs, music downloads, movie DVDs, movie home video, movie downloads and video games.

14. The method of claim 1 wherein said trends comprise social mood trends.

15. The method of claim 1 further comprising communicating results of said trends through a visual representation of said data.

16. The method of claim 15 wherein said visual representation of said data comprises a graph or chart.

17. The method of claim 1 further comprising using said genre index to predict successful projects for production.

18. The method of claim 1 further comprising using said genre index to enable investors to build diversified synthetic libraries of projects.

19. The method of claim 1 further comprising using said genre index to hedge against underperforming project selection in a particular genre in a particular industry.

20. The method of claim 1 further comprising using said genre index to directly trade trends in specific genres in the market.

21. The method of claim 1 further comprising using said genre index to perform arbitrage in the market.

22. The method of claim 1 further comprising converting said genre index into a tradable instrument.

23. The method of claim 1 further comprising converting said genre index into one or more investable products.

24. The method of claim 23 further comprising converting said genre index into investable products on a cash-settled basis.

25. The method of claim 1 further comprising licensing rights to use said genre index to futures, options, or stock exchanges.

26. The method of claim 1 further comprising licensing rights to use said genre index to money management firms or investment banks to create investable products.

27. The method of claim 26 wherein said investable products are selected from a group of mutual funds, hedge funds, and exchange traded funds.

28. The method of claim 1 further comprising using said genre index to produce a consumer confidence index.

29. The method of claim 1 further comprising using said genre index to license rights to use said genre index to third party data suppliers.

30. A method of creating a tradable instrument for the purpose of exchange within a financial market comprised of:
a. collecting volume data for one or more products in one or more industries;
b. quantifying said volume data;
c. segregating said volume data by genre category;
d. analyzing said data for the purpose of identifying trends in the data; and
e. converting said data into a tradable instrument on a cash-settled basis.

31. The method of claim 30 further comprising comparing said tradable instrument against other similar tradable instruments in various genres to mine for useful information.

32. The method of claim 30 further comprising licensing rights to use said tradable instrument to various futures, options, and stock exchanges.

33. The method of claim 30 further comprising using said tradable instrument to license rights to use said tradable instrument to money management firms or investment banks to create one or more investable products.

34. The method of claim 33 wherein said one or more investable products are selected from a group of mutual funds, hedge funds, and exchange traded funds.

35. The method of claim 30 further comprising licensing rights to use said tradable instrument to third-party data suppliers.
